(19) United States
(12) Patent Application Publication
(10) Pub. No.: US 2026/0111340 A1
(43) Pub. Date: Apr. 23, 2026

(54) INTELLIGENT TEST SELECTION BASED ON BIG-DATA ANALYSIS AND MACHINE LEARNING

(71) Applicant: Oracle International Corporation, Redwood Shores, CA (US)

(72) Inventors: Qi Dai, Beijing (CN); Yi Zhang, Beijing (CN); Chuanjuan Yu, Beijing (CN)

(73) Assignee: Oracle International Corporation, Redwood Shores, CA (US)

(21) Appl. No.: 16/468,620

(22) PCT Filed: May 17, 2019
(86) PCT No.: PCT/CN2019/087437

§ 371 Date: Jun. 11, 2019

(51) Int. Cl. G06F 11/3604

(52) U.S. Cl. CPC G06F 11/3608; G06F 11/3616

(57) ABSTRACT

The present disclosure generally relates to systems and methods for intelligently predicting which tests to run on modified source code of an enterprise application. More specifically, the present disclosure relates to systems and methods that build a model using machine-learning algorithms to predict which tests to run on modified source code. The prediction may be based on the modification made to the application code of the enterprise application.

### TECHNICAL FIELD

The present disclosure generally relates to systems and methods for intelligently predicting which tests to run on modified application code of an enterprise application. More specifically, the present disclosure relates to systems and methods that build a model using machine-learning algorithms to predict which tests to run based on the modification made to the application code of the enterprise application.

### BACKGROUND

Enterprise applications provide various services and functionality to companies. However, enterprise applications are deployed using potentially millions of lines of application code. Further, various teams of developers around the world frequently modify and update the application code in a continuous integration environment. Every code change requires a test engineer to run various test cases to verify whether the modified portions of the application code are free of bugs or other errors. At the same time, the number of test cases is quickly increasing to improve the security and reliability of the enterprise applications. As the overall number of test cases grows, so too does the maintenance cost involved in testing the enterprise applications for errors.

Traditionally, test engineers manually select the appropriate test cases to check for errors in the modified portion of the application code. However, it is a significant challenge to select the appropriate test cases from a very large number of available test cases. Currently, in the industry, test engineers typically select test cases based on experience, however, it is difficult to ensure a comprehensive, reliably selected set of test cases when the test cases are selected based on experience alone.

### BRIEF SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Continuous integration is a software development practice where members of a team frequently integrate their work (e.g., feature updates or modifications) into an enterprise software application. Each integration can be verified by automated software tests that detect errors caused by the integration of modified source code. Further, version control systems can be used to manage revisions made to the source code of the enterprise software application for each integration. In particular, version control systems can capture a timestamp associated with every revision made to the underlying code and the individual who made the revisions (e.g., the software engineer or developer). A continuous integration development environment may be an enterprise software application (e.g., a PEOPLESOFT application with millions of lines of code) that can be revised, modified, edited, or changed over time by different teams of developers. Further, a unit of work delivery may be a particular instance of revisions made to the source code of the enterprise software application. For example, a unit of work delivery may include source code, binary code, and/or configuration files that were modified by a developer.

Before integrating the unit of work delivery (e.g., revisions made to the source code) into the source code of the enterprise software application, the software application including the unit of work delivery is generally tested to determine whether the unit of work delivery would cause bugs or errors if integrated into the source code. Running all available test cases is extremely time consuming, costly, and burdensome on processing resources. As such, to address the risk of errors, test engineers select specific test cases from all available test cases. Traditionally, test cases are selected based on the experience of the testing engineer. For example, if function X is modified in the source code, a test engineer may know that Test A, Test B, and Test C are the best tests to run on the modified source code to identify bugs or errors. However, as the complexity of the source code and the number of available test cases grows at a fast pace, the selection of tests by test engineers becomes increasingly difficult and unreliable.

Certain embodiments of the present disclosure relate to systems and methods that use machine-learning and/or artificial intelligence to intelligently predict a set of test cases to run on modified source code. Further, certain embodiments of the present disclosure relate to systems and methods that collect a data set representing any change made by a test engineer to an initial set of tests. For example, a test prediction system can evaluate the modifications made to the source code by developers (e.g., the additional of a function to the application code, the modification of an existing function within the application code, and so on). The test prediction system can automatically determine an initial set of test cases to provide to the test engineer as a suggestion of test cases to run on the modified application code. As a non-limiting example, the initial set of test cases can be determined based on the type of modification made, such as modifying the code representing features of an existing function. The test engineer can then accept and perform each of the initial set of test cases, select an additional one or more test cases to add to the initial set of test cases, and/or remove one or more test cases from the initial set of test cases. In any of these instances, the test prediction system can collect the selection and any metadata associated with the selection into a data set. For example, if the test engineer adds a test case to the initial set of test cases, the test prediction system can store data representing the selection in a data set. The data representing the selection can, for example, include whether or not a test was added or removed, a unique identifier of a test that was added or removed, a unique identifier of the function that was modified, a unique identifier of the test engineer who selected a test for addition to or removal from the initial set of test cases, and other suitable information. Over time, the collected data set can become quite large (e.g., reaching big-data scale). The test prediction system can then use the collected data set to train a machine-learning model, which can be configured to identify patterns within the collected data set. The trained model can then be used to generate a prediction of test cases to run on the modified prediction code.

Advantageously, certain embodiments relate to systems and methods that define a criteria to build a complex test selection pattern or model based on any changes made to the application code of an enterprise application (e.g., code change, code coverage, risk classifications, history outstanding bugs, function categories, previous selection log, and so on). The complex test selection pattern or model can evaluate any changes to the application code and predict the most appropriate test cases to select to test a given modification to the application code. In addition, certain embodiments relate to generating an initial test suite as an initial output, then receiving input from a testing engineer based on his or her experience. The testing engineer can delete one or more test cases or add one or more additional test cases to the initial test suite to improve the robustness of the selection, which will enable more precise testing. During this process, the test prediction system can apply machine-learning and/or artificial intelligence techniques to learn from the changes the test engineer made to the initial test suite. The prediction capabilities of the model can be continuously improved each instance the test engineer adds or removes a test case from the initial test suite. After the final test suite is determined by the test engineer, certain embodiments may provide the ability to execute any test cases that include an automated script.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method including: identifying an enterprise application configured to perform one or more functions, the enterprise application being executed using application code; detecting a modification to the application code; determining a set of tests, the determination being based at least in part on the modification to the application code, and each test of the set of tests being executable to detect an error in the modified application code; receiving input corresponding to a selection of an additional test to include in the set of tests or of a test to remove from the set of tests. The computer-implemented method also includes collecting a data set representing the selection and one or more additional selections, each of the selection and the one or more additional selections representing a change to the set of tests. The computer-implemented method also includes generating a model to predict which tests to include in the set of tests, the model being generated by training one or more machine-learning algorithms using the collected data set. The computer-implemented method also includes detecting an additional modification to the application code. The computer-implemented method also includes evaluating the additional modification using the generated model. The computer-implemented method also includes in response to evaluating the additional modification using the generated model, generating a predicted set of tests to execute on the application code as modified by the additional modification. Other embodiments of this aspect include corresponding computer systems, apparatus, and computer programs recorded on one or more computer storage devices, each configured to perform the actions of the methods.

One general aspect includes a system, including: one or more data processors; and a non-transitory computer-readable storage medium containing instructions which, when executed on the one or more data processors, cause the one or more data processors to perform operations including: identifying an enterprise application configured to perform one or more functions, the enterprise application being executed using application code. The operations also include detecting a modification to the application code. The operations also include determining a set of tests, the determination being based at least in part on the modification to the application code, and each test of the set of tests being executable to detect an error in the modified application code. The operations also include receiving input corresponding to a selection of an additional test to include in the set of tests or of a test to remove from the set of tests. The operations also include collecting a data set representing the selection and one or more additional selections, each of the selection and the one or more additional selections representing a change to the set of tests. The operations also include generating a model to predict which tests to include in the set of tests, the model being generated by training one or more machine-learning algorithms using the collected data set. The operations also include detecting an additional modification to the application code. The operations also include evaluating the additional modification using the generated model. The operations also include in response to evaluating the additional modification using the generated model, generating a predicted set of tests to execute on the application code as modified by the additional modification. Other embodiments of this aspect include corresponding computer systems, apparatus, and computer programs recorded on one or more computer storage devices, each configured to perform the actions of the methods.

One general aspect includes a computer-program product tangibly embodied in a non-transitory machine-readable storage medium, including instructions configured to cause a data processing apparatus to perform operations including identifying an enterprise application configured to perform one or more functions, the enterprise application being executed using application code; detecting a modification to the application code; determining a set of tests, the determination being based at least in part on the modification to the application code, and each test of the set of tests being executable to detect an error in the modified application code; receiving input corresponding to a selection of an additional test to include in the set of tests or of a test to remove from the set of tests. The computer-program product also includes collecting a data set representing the selection and one or more additional selections, each of the selection and the one or more additional selections representing a change to the set of tests. The computer-program product also includes generating a model to predict which tests to include in the set of tests, the model being generated by training one or more machine-learning algorithms using the collected data set. The computer-program product also includes detecting an additional modification to the application code. The computer-program product also includes evaluating the additional modification using the generated model. The computer-program product also includes in response to evaluating the additional modification using the generated model, generating a predicted set of tests to execute on the application code as modified by the additional modification. Other embodiments of this aspect include corresponding computer systems, apparatus, and computer programs recorded on one or more computer storage devices, each configured to perform the actions of the methods.

### BRIEF DESCRIPTION OF THE DRAWINGS

The specification makes reference to the following appended figures, in which use of like reference numerals in different figures is intended to illustrate like or analogous components.

FIG. 1A illustrates an example system for configuring, collecting, and analyzing log data, according to certain embodiments.

FIG. 1B shows a flowchart of an approach to use a system to configure, collect, and analyze log data, according to certain embodiments.

FIG. 2 is a block diagram illustrating components of a reporting user interface (UI), according to certain embodiments.

FIG. 3A is a block diagram illustrating an example internal structure of the log analytics system, according to certain embodiments.

FIG. 3B is a block diagram illustrating an example internal structure of the log analytics system, according to other embodiments.

FIG. 3C is a block diagram illustrating an example internal structure of the log analytics system, according to other embodiments.

FIG. 4 is a block diagram illustrating an example network environment that intelligently selects test cases to run for error checking modified application code of an enterprise application.

FIG. 5 is a diagram illustrating a process flow for intelligently selecting test cases using machine-learning and/or artificial intelligence techniques.

FIG. 6 is a flowchart illustrating an example process for intelligently selecting test cases using machine-learning and/or artificial intelligence techniques.

FIG. 7 illustrates a simplified diagram of a distributed system for implementing an embodiment of the present disclosure.

FIG. 8 illustrates a simplified diagram of a distributed system for implementing an embodiment of the present disclosure.

FIG. 9 illustrates an exemplary computer system that may be used to implement an embodiment.

### DETAILED DESCRIPTION

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

In the following description, for the purposes of explanation, specific details are set forth in order to provide a thorough understanding of embodiments of the invention. However, it will be apparent that various embodiments may be practiced without these specific details. The figures and description are not intended to be restrictive.

Many types of computing systems and applications generate vast amounts of data pertaining or resulting from operation of that computing system or application. These vast amounts of data are frequently then stored into collected locations, such as log files/records, which can be reviewed at a later time period if there is a need to analyze the behavior or operation of the system or application.

While the below description may describe embodiments by way of illustration with respect to “log” data, processing of other types of data are further contemplated. Therefore, embodiments are not to be limited in its application only to log data. In addition, the following description may also interchangeably refer to the data being processed as “records” or “messages”, without intent to limit the scope of the invention to any particular format for the data.

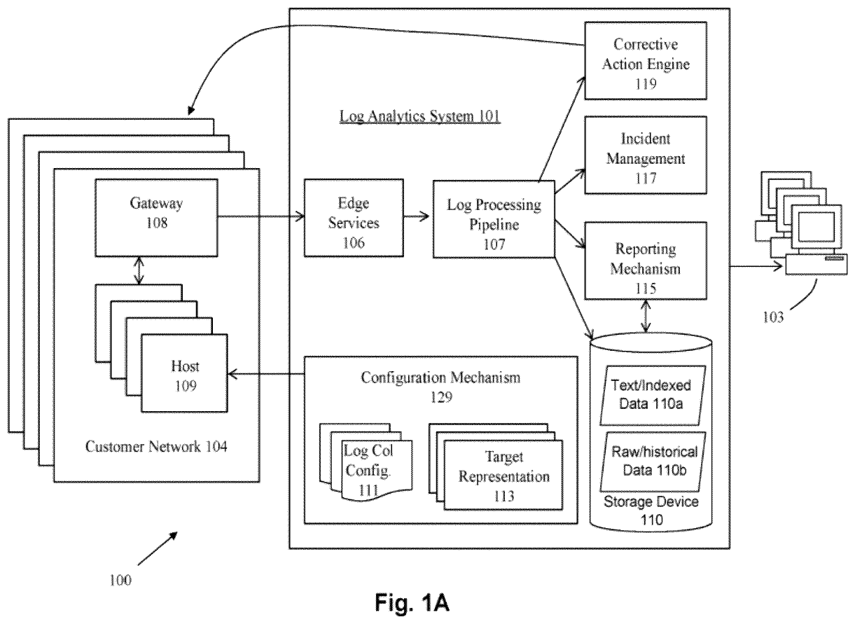

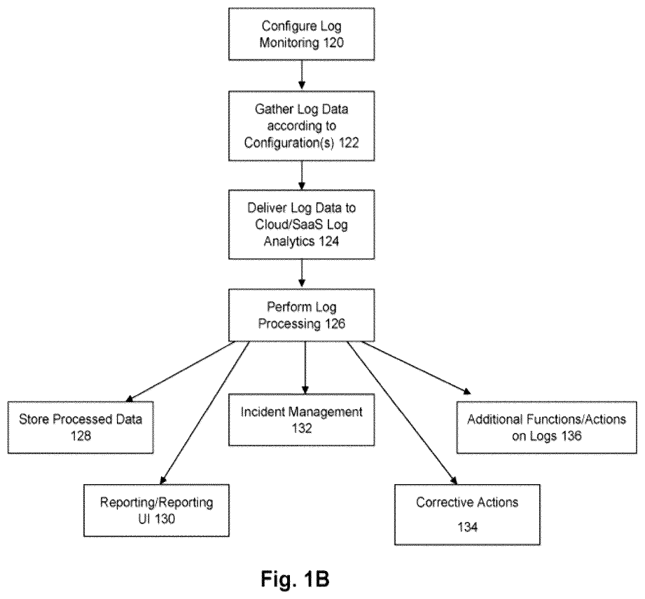

FIG. 1A illustrates an example system 100 for configuring, collecting, and analyzing log data according to some embodiments of the invention. System 100 includes a log analytics system 101 that in some embodiments is embodied as a cloud-based and/or SaaS-based (software as a service) architecture. This means that log analytics system 101 is capable of servicing log analytics functionality as a service on a hosted platform, such that each user that needs the service does not need to individually install and configure the service components on the user's own network. The log analytics system 101 is capable of providing the log analytics service to multiple separate users, and can be scaled to service any number of users.

Each user network 104 may include any number of hosts 109. The hosts 109 are the computing platforms within the user network 104 that generate log data as one or more log files. The raw log data produced within hosts 109 may originate from any log-producing source. For example, the raw log data may originate from a database management system (DBMS), database application (DB App), middleware, operating system, hardware components, or any other log-producing application, component, or system. One or more gateways 108 are provided in each user network to communicate with the log analytics system 101.

The system 100 may include one or more users at one or more user stations 103 that use the system 100 to operate and interact with the log analytics system 101. The user station 103 comprises any type of computing station that may be used to operate or interface with the log analytics system 101 in the system 100. Examples of such user stations include, for example, workstations, personal computers, mobile devices, or remote computing terminals. The user station comprises a display device, such as a display monitor, for displaying a user interface to users at the user station. The user station also comprises one or more input devices for the user to provide operational control over the activities of the system 100, such as a mouse or keyboard to manipulate a pointing object in a graphical user interface to generate user inputs. In some embodiments, the user stations 103 may be (although not required to be) located within the user network 104.

The log analytics system 101 comprises functionality that is accessible to users at the user stations 101, where log analytics system 101 is implemented as a set of engines, mechanisms, and/or modules (whether hardware, software, or a mixture of hardware and software) to perform configuration, collection, and analysis of log data. A user interface (UI) mechanism generates the UI to display the classification and analysis results, and to allow the user to interact with the log analytics system.

FIG. 1B shows a flowchart of an approach to use system 100 to configure, collect, and analyze log data. This discussion of FIG. 1B will refer to components illustrated for the system 100 in FIG. 1A.

At 120, log monitoring is configured within the system. This may occur, for example, by a user to configure the type of log monitoring/data gathering desired by the user. Within system 101, a configuration mechanism 129 comprising UI controls is operable by the user to select and configure log collection configuration 111 and target representations 113 for the log collection configuration.

The log collection configuration 111 comprises the set of information (e.g., log rules, log source information, and log type information) that identify what data to collect (e.g., which log files), the location of the data to collect (e.g., directory locations), how to access the data (e.g., the format of the log and/or specific fields within the log to acquire), and/or when to collect the data (e.g., on a periodic basis). The log collection configuration 111 may include out-of-the-box rules that are included by a service provider. The log collection configuration 111 may also include user-defined/user-customized rules.

The target representations 113 identify “targets”, which are individual components within the user environment that that contain and/or produce logs. These targets are associated with specific components/hosts in the user environment. An example target may be a specific database application, which is associated with one or more logs and/or one or more hosts.

The next action at 122 is to capture the log data according to the user configurations. The log data may originate from any log-producing source location, such as a database management system, database application, middleware, hardware logs, operating system logs, application logs, application server logs, database server logs, and any other type of log that monitors the behavior of a system or application.

In some instances, the association between the log rules 111 and the target representations is sent to the user network 104 for processing. An agent of the log analytics system is present on each of the hosts 109 to collect data from the appropriate logs on the hosts 109.

In some embodiments, data masking may be performed upon the captured data. The masking is performed at collection time, which protects the user data before it leaves the user network. For example, various types of information in the collected log data (such as user names and other personal information) may be sensitive enough to be masked before it is sent to the server. Patterns are identified for such data, which can be removed and/or changed to proxy data before it is collected for the server. This allows the data to still be used for analysis purposes, while hiding the sensitive data. Some embodiments permanently remove the sensitive data (e.g., change all such data to “***” symbols), or changed to data that is mapped so that the original data can be recovered.

At 124, the collected log data is delivered from the user network 104 to the log analytics system 101. The multiple hosts 109 in the user network 104 provide the collected data to a smaller number of one or more gateways 108, which then sends the log data to edge services 106 at the log analytics system 101. The edge services 106 receives the collected data one or more user networks, perform any intake processing (e.g., applying grammar rules to transform each message into a normalized message or skeleton message that lacks components of inter-cluster message variability and assigning each transformed message to an initial cluster identified using a hash of the transformed message) and may place the data into an inbound data store for further processing by a log processing pipeline 107.

At 126, the log processing pipeline 107 performs a series of data processing and analytical operations upon the collected log data. In various instances, the processing and analytical operations can include actions performed prior to storing the data and/or by performing actions on data retrieved from a data store. For example, one or more log messages may be assigned to initial clusters at an ingest time (e.g., upon receiving the log message(s) from a source), and the log message(s) may be subsequently retrieved in response to a query to modify or supplement the initial clustering and generate statistics and/or presentations based on the clustering.

At 128, the processed data is then stored into a data storage device 110. The computer readable storage device 110 comprises any combination of hardware and software that allows for ready access to the data that is located at the computer readable storage device 110. For example, the computer readable storage device 110 could be implemented as computer memory operatively managed by an operating system. The data in the computer readable storage device 110 could also be implemented as database objects, cloud objects, and/or files in a file system. In some embodiments, the processed data is stored within both a text/indexed data store 110a (e.g., as a SOLR cluster) and a raw/historical data store 110b (e.g., as a HDFS cluster).

A SOLR cluster corresponds to an Apache™ open source enterprise search platform. The SOLR cluster can use a search library to perform full-text indexing and searching of data stored in a HDFS cluster. The SOLR cluster can provide APIs compatible with various languages to interface the searching functions with other programs and applications. Indexing can be performed in near real-time. The cluster can operate on a set of servers so as to facilitate fault tolerance and availability. Indexing and search tasks can be distributed across the set of servers.

An HDFS cluster corresponds to a Hadoop Distributed File System cluster. The HDFS cluster can include many (e.g., thousands) of servers to host storage (e.g., directly attached storage) and execute tasks, such as tasks defined by user applications. The HDFS cluster can include a master/slave architecture with a single master server for managing a namespace of the cluster. A file can be divided into blocks to be stored at multiple DataNodes of the HDFS cluster. The master server can perform file operations (e.g., open, close, etc.) and determine which blocks are to be stored on which data nodes. The master server can communicate with data nodes for requests to read or write data in response to receipt of corresponding file operations.

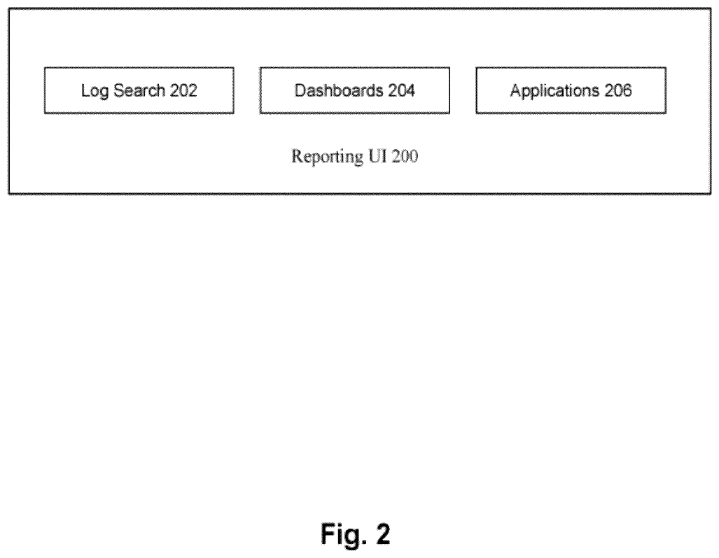

At 130, reporting may be performed on the processed data using a reporting mechanism/UI 115. As illustrated in FIG. 2, the reporting UI 200 may include a log search facility 202, one or more dashboards 204, and/or any suitable applications 206 for analyzing/viewing the processed log data. Examples of such reporting components are described in more detail below.

At 132, incident management may be performed upon the processed data. One or more alert conditions can be configured within log analytics system such that upon the detection of the alert condition, an incident management mechanism 117 provides a notification to a designated set of users of the incident/alert.

At 134, a Corrective Action Engine 119 may perform any necessary actions to be taken within the user network 104. For example, a log entry may be received that a database system is down. When such a log entry is identified, a possible automated corrective action is to attempt to bring the database system back up. The user may create a corrective action script to address this situation. A trigger may be performed to run the script to perform the corrective action (e.g., the trigger causes an instruction to be sent to the agent on the user network to run the script). In an alternative embodiment, the appropriate script for the situation is pushed down from the server to the user network to be executed. In addition, at 136, any other additional functions and/or actions may be taken as appropriate based at last upon the processed data.

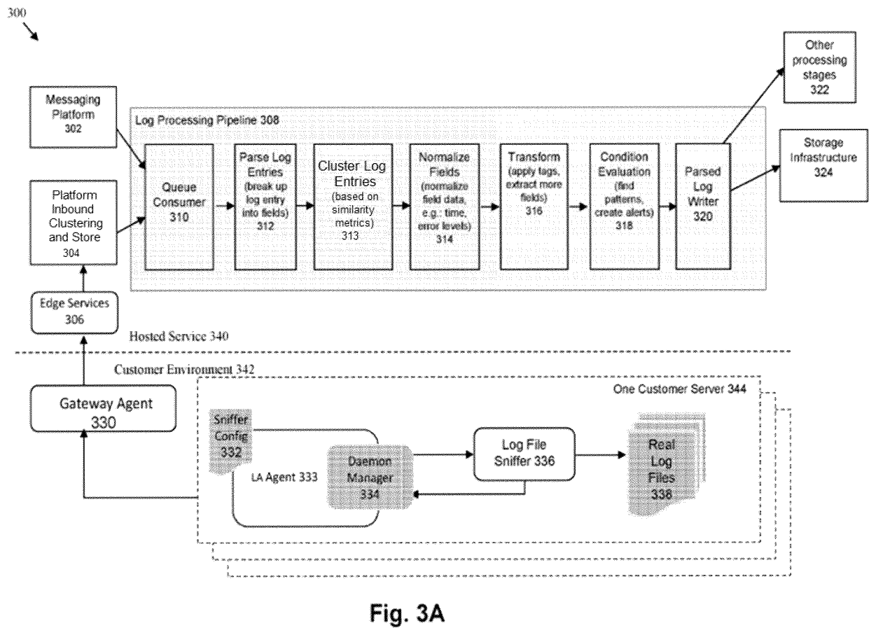

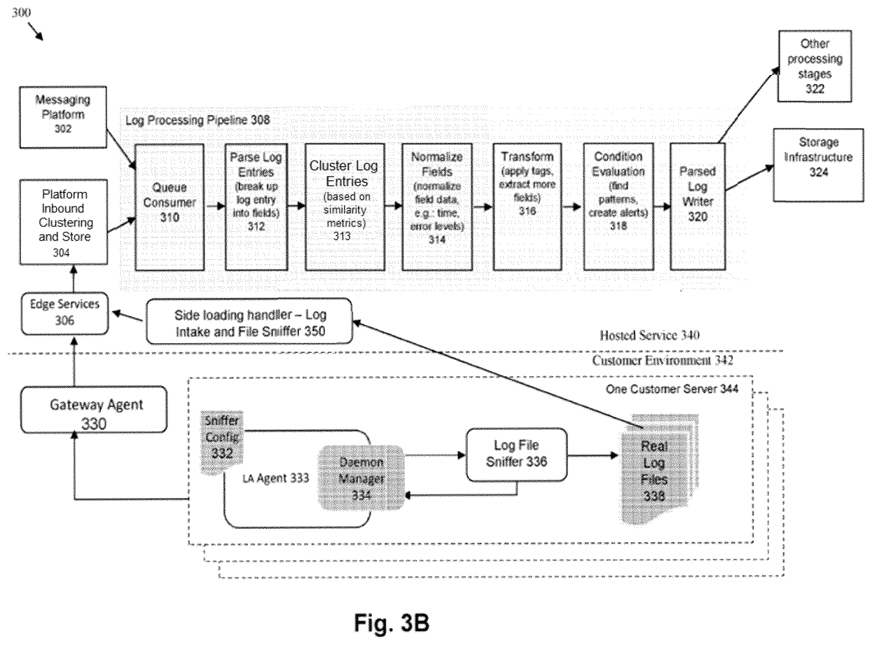

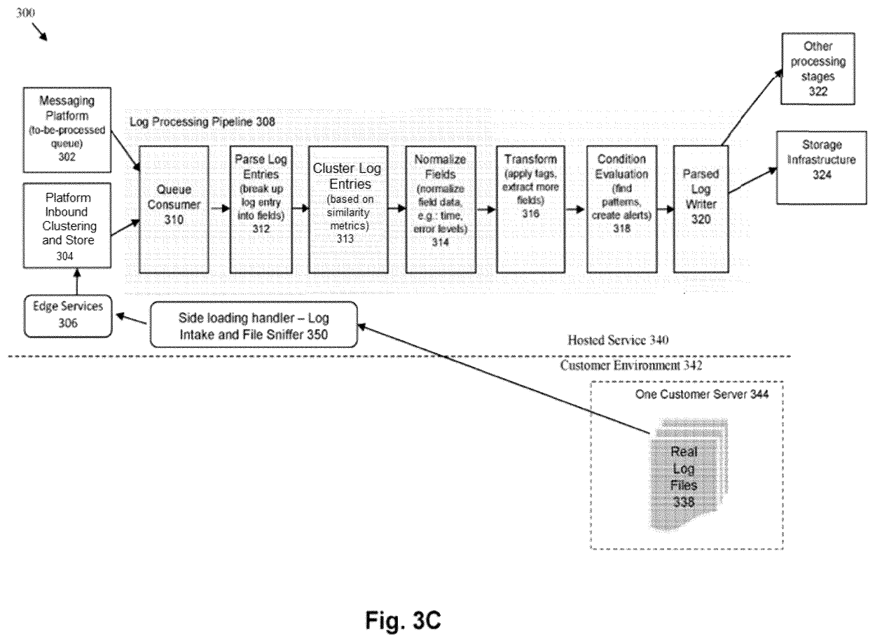

FIG. 3A provides a more detailed illustration of the internal structure of the log analytics system at a host environment 340 and the components within the user environment 342 that interact with the log analytics system. This architecture 300 is configured to provide a flow for log monitoring that is able to handle large amounts of log data ingest.

In the user environment 342 within a single user host/server 344, the LA (log analytics) agent 333 takes the log monitoring configuration data 332 (e.g., sniffer configuration or target-side configuration materials), and calls a log file 336 sniffer (also referred to herein as the “log collector”) to gather log data from one or more log files 338.

A daemon manager 334 can be employed to interface with the log file sniffer 336. The log file sniffer 336 reads from one or more log files 338 on the host machine 344. The daemon manager 334 takes the log content and packages it up so that it can be handed back to the LA agent 333. It is noted that the system may include any number of different kinds of sniffers, and a log sniffer 336 is merely an example of a single type of sniffer that can be used in the system. Other types of sniffers may therefore be employed within various embodiments of the invention, e.g., sniffers to monitor registries, databases, windows event logs, etc. In addition, the log sniffer in some embodiments is configured to handle collective/compressed files, e.g., a Zip file.

The LA agent 333 sends the gathered log data to the gateway agent 330. The gateway agent 330 packages up the log data that is collected from multiple user hosts/servers, essentially acting as an aggregator to aggregate the log content from multiple hosts. The packaged content is then sent from the gateway agent 330 to the edge services 306. The edge services 306 receive a large amount of data from multiple gateway agents 330 from any number of different user environments 342.

Given the potentially large volume of data that may be received at the edge services 306, the data can be immediately processed to assign each log message to an initial cluster and stored into an inbound data storage device 304 (the “platform inbound clustering store”). In some instances, an initial or preliminary processing may be performed at an ingest time, which can include a time corresponding to (e.g., before, shortly or immediately after, or concurrent with) storage of the data. The initial or preliminary processing may include (for example) detecting which parts of the data are non-variable components and determining an initial cluster for each log message based on the non-variable components detected in the message. For example, a hashing technique may be applied to a value of each non-variable component to generate an identifier of the initial cluster. The log message may then be stored in association with the identifier of the initial cluster or other cluster data can be stored to indicate that the log message is associated with the initial cluster. Cluster assignments may be further refined, enhanced and/or used during subsequent processing, such as during processing that occurs during a time of subsequent resource availability and/or in response to receiving a query for data corresponding to or potentially corresponding to the associated log messages.

Thus, in some instances, a queue is managed and maintained, where queue elements corresponding to one or more log messages for which cluster assignments are to be refined, enhanced and/or used. An element may be added to the queue (for example) subsequent to an initial storing of the queue element and/or in response to receiving a query for data corresponding to or potentially corresponding to one or more associated log messages. The queue can be used for the log processing pipeline 308.

A data structure is provided to manage the items to be processed within the inbound data store. In some embodiments, a messaging platform 302 (e.g., implemented using the Kafka product) can be used to track the to-be-processed items within the queue. Within the log processing pipeline 308, a queue consumer 310 identifies the next item within the queue to be processed, which is then retrieved from the platform inbound store. The queue consumer 310 comprises any entity that is capable of processing work within the system off the queue, such as a process, thread, node, or task.

The retrieved log data undergoes a “parse” stage 312, where the log entries are parsed and broken up into specific fields or components. The “log type” configured for the log specifics how to break up the log entry into the desired fields.

At a “cluster” stage 313, log data is further analyzed to assign individual log messages to a cluster. Specifically, multiple initial clusters to which log messages were assigned during an intake process (e.g., at 304) can be assessed to determine whether some of the initial clusters are to be merged together. The assessment can include identifying one or more representative samples for each cluster and performing pair-wise quantitative comparative assessments. Cluster pairs assessed via a pair-wise comparative assessment can include clusters with log messages having same or similar number of components (or words). In some instances, each pair of clusters includes clusters associated with a number of components that are the same or different from each other by less than a threshold number (e.g., that is predefined, a default number, or identified by a user) is evaluated using the assessment. The comparative assessment may be performed iteratively and/or in a structured manner (e.g., such that pairs with a same number of components are evaluated prior to evaluating pairs with a different number of components).

The pair-wise quantitative comparative assessment can include, for example, generating a similarity metric using the representative messages and determining whether the metric exceeds a threshold metric (e.g., that is predefined, a default number of identified by a user). The similarity metric may be based on (for example) whether the representative messages include a same (or similar) number of components, number of variable (or non-variable) components, content of each of one or more non-variable components, characteristic (e.g., format, character type or length) of one or more variable components, and so on. The similarity metric may be based on generating a correlation coefficient between the inter-cluster messages or by performing a clustering technique using a larger set of messages to an extent to which representative messages of the clusters are assigned to a same cluster or share components (e.g., if a technique includes using a component analysis, such as principal component analysis or independent component analysis.

In the “normalize” stage 314, the identified fields are normalized. For example, a “time” field may be represented in any number of different ways in different logs. This time field can be normalized into a single recognizable format (e.g., UTC format). As another example, the word “error” may be represented in different ways on different systems (e.g., all upper case “ERROR”, all lower case “error”, first letter capitalized “Error”, or abbreviation “er”). This situation may require the different word forms/types to be normalized into a single format (e.g., all lower case un-abbreviated term “error”).

The “transform” stage 316 can be used to synthesize new content from the log data. As an example, “tags” can be added to the log data to provide additional information about the log entries. As another example, a tag may identify a cluster to which a log message is assigned.

A “condition evaluation” stage 318 is used to evaluate for specified conditions upon the log data. This stage can be performed to identify patterns within the log data, and to create/identify alerts conditions within the logs. Any type of notifications may be performed at this stage, including for example, emails/text messages/call sent to administrators/users or alert to another system or mechanism. As one example, a condition may define an event that corresponds to a change in cluster assignments, such as detecting that a quantity (e.g., number or percentage) of log messages assigned to a given cluster has exceeded a threshold (e.g., that is fixe and pre-defined or defined by a user, a client or rule), such as being below a lower threshold or above an upper threshold. As another example, a condition may define an event that corresponds to a degree to which a quantity of log messages being assigned to a given threshold is changing, such as by identifying a threshold for a slope of a time series or a threshold for a difference in counts or percentages or log message assigned to the cluster between two time bins. As yet another example, a condition may define an event that corresponds to multiple cluster assignments, such as an event that indicates that a time series of each of the multiple clusters has a similar shape (e.g., by determining whether curve-fit coefficients are similar enough to be within a threshold amount, by determining whether a time of one or more peaks in time series are within a defined threshold time, determining whether a correlation coefficient between time series of the clusters exceeds a threshold, and/or determining whether a difference between a variability of a time series of each of the individual clusters and a variability of a sum of the time series exceeds a threshold value).

A log writer 320 then writes the processed log data to one or more data stores 324. In some embodiments, the processed data is stored within both a text/indexed data store (e.g., as a SOLR cluster) and a raw and/or historical data store (e.g., as a HDFS cluster). The log writer can also send the log data to another processing stage 322 and/or downstream processing engine.

As shown in FIG. 3B, some embodiments provide a side loading mechanism 350 to collect log data without needing to proceed through an agent 333 on the client side. In this approach, the user logs into the server to select one or more files on a local system. The system will load that file at the server, and will sniff through that file (e.g., by having the user provide the log type, attempting likely log types, rolling through different log types, or by making an educated “guess” of the log type). The sniffing results are then passed to the Edge Services and process as previously described. In the embodiment, of FIG. 3C, only the side loading mechanism 350 exists to gather the log files-where the agent/sniffer entities are either not installed and/or not needed on the client server 344.

Continuous integration is a software development practice where members of a team frequently integrate their work into an enterprise software application. Each integration can be verified by automated software tests that detect errors caused by the integration or modified application code. Further, version control systems can be used to manage revisions made to the code of the software application for each integration. In particular, version control systems can capture a timestamp associated with every revision made to the underlying code and the individual who made the revisions (e.g., the software engineer or developer). A continuous integration development environment may be an enterprise software application (e.g., a PEOPLESOFT application with millions of lines of code) that can be revised, modified, edited, or changed over time by different teams of developers. Further, a unit of work delivery may be a particular instance of revisions made to the source code of the enterprise software application. For example, a unit of work delivery may include source code, binary code, and/or configuration files that were modified by a developer. Before integrating the unit of work delivery (e.g., revisions made to the source code) into the source code of the enterprise software application, the software application including the unit of work delivery is generally tested to determine whether the unit of work delivery would cause bugs or errors if integrated into the source code.

Additionally, when the unit of work delivery is submitted for testing, a version control system (not shown) can be queried to determine the files that have been modified (e.g., the modified source code). The version control system can access a baseline version of the software application (e.g., the source code before the unit of work delivery) and a modified version of the software application (e.g., the source code including the unit of work delivery). Each of the baseline version and the modified version of the software application can be compiled to generate binary code (e.g., machine-readable code). The binary code of the baseline version can be compared with the binary code of the modified version of the software application to identify the functions that are affected by the revisions included in the unit of work delivery. A test engineer may select one or more tests (typically the tests that are associated with the identified functions that are modified) that are then grouped as a subset of tests to be executed during the testing phase. The tests in the subset of tests may include a threshold number of tests that are predicted based on the revisions made to the source code in the unit of work delivery. A test prediction system can collect information about the selections made by the various test engineers and train a machine-learning-based model to predict the best suited tests to run on the modified source code.

Certain embodiments of the present disclosure involve collecting a data set representing each selection made by a test engineer to accept, add or remove test cases from an initial set of test cases presented to the test engineer. The metadata associated with each selection to accept, add or remove test cases from the initial set of test cases can be stored with respect to the specific test engineer who made the selection. Other selections to change the tests within an initial set of tests made by other test engineers for the same enterprise application or for different enterprise applications can also be collected and stored in a data set. In some implementations, a test prediction system can train a model using the collected data set. The test prediction system can run one or more machine-learning or artificial intelligence algorithms on the collected data set to identify patterns between data items within the collected data set. For example, the machine-learning techniques may include, for example, one or more machine-learning algorithms, such as an ensemble of multi-label classifiers (e.g., supervised or unsupervised learning), artificial neural networks (including backpropagation, Boltzmann machines, etc.), Bayesian statistics (e.g., Bayesian networks or knowledge bases), logistical model trees, support vector machines, information fuzzy networks, Hidden Markov models, hierarchical clustering (unsupervised), self-organizing maps, clustering techniques, and other suitable machine-learning techniques (supervised, semi-supervised, or unsupervised). The detected patterns can be used to define a selection criteria used by the test prediction system to intelligently predict which test cases should be executed on the application code in response to a detection that the application code has been modified. As a non-limiting example, if function X within the application code has been modified by a developer, the test prediction system can evaluate the modification to function X using the trained machine-learning model to generate an output that corresponds to a prediction of which test cases to run on the modified application code of the enterprise application. If the test cases included in the list of predicted test cases (e.g., the output of the model) include automated script, then the test cases may be executed automatically. For example, an automated software test may be a test that is executed automatically by software test tools (e.g., PEOPLETOOLS Test Framework, SELENIUM and WINRUNNER, etc.) that can execute pre-scripted tests on a software application. An automated software test can also be any set of test inputs, execution conditions, and expected results developed for a particular objective, such as to exercise a particular program path or to verify compliance with a specific requirement.

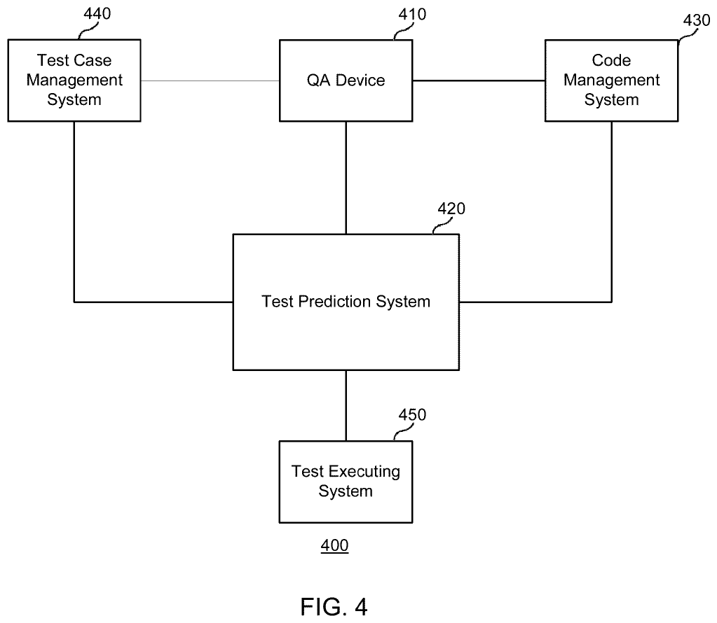

FIG. 4 is a block diagram illustrating network environment 400, which enables test prediction system 420 to intelligently select test cases to run for error checking the modified application code of an enterprise application. In some implementations, network environment 400 may include quality assurance (QA) device 410, test prediction system 420, code management system 430, test case management system 440, and test executing system 450. Network environment 400 provides test prediction system 420 with a network to collect data from various QA devices (including QA device 410). The data collected may relate to any adjustments made to test suites (e.g., the initial set of test cases presented to QA device 410). For example, adjustments may include accepting the initial set of test cases, adding one or more test cases to the initial set of test cases, or removing one or more tests from the initial set of test cases. Further, network environment 400 enables test prediction system 420 to train a machine-learning model to identify patterns within the collected data set, so as to generate a prediction of test cases to run on the modified application code.

QA device 410 may be any end-user device operated by an end user, such as a quality assurance engineer or test engineer. For example, an end-user device may be any portable (e.g., smartphone, laptop, tablet computer, etc.) or non-portable (e.g., desktop, electronic kiosk, etc.) computing device. QA device 410 may communicate with test case management system 440 to retrieve all available test cases from which the test engineer can select. Test case management system 440 may include a network of one or more servers and/or one or more databases that store all of the available test cases that can be performed on any enterprise application or non-enterprise application. As a non-limiting example, QA device 410 may include a screen that displays a selectable drop-down menu of the entire set of available test cases or a subset thereof. Additionally, QA device 410 can access code management system 430 to retrieve or at least identify the modifications made to the application code of the enterprise application. Code management system 430 may include a network of one or more servers that can access one or more databases storing the application code of the enterprise application. Further, code management system 430 can store any modifications made to the application code by a developer or team of developers. As a non-limiting example, a developer may modify function X of the application code to add a new feature or characteristic to function X. The modification made to the application code may be stored (with or without the remaining application code) at code management system 430. As such, QA device 410 can retrieve the modification or entire application code with the modification from code management system 430.

Based on the available test cases and the modification made to the application code by one or more developers, the test engineer operating QA device 410 can select a set of tests that are most appropriate to run on the modified application code. Performing all tests available typically takes several days and potentially more than a week to perform, and thus, heavily burdens processing systems. To avoid this, test engineers typically select a set of test cases to run based on their experience. However, relying on the selection of test cases by a test engineer is burdensome and unreliable because the number of available tests and the complexity of the source code being tested is growing at a fast pace. Test prediction system 420 can determine or identify an initial set of test cases to run and present the initial set of test cases on QA device 410. In some implementations, the initial set of test cases can be determined based one or more rules used to evaluate the modified application code. For example, if functions are updated in the modified application code, then certain test cases can be selected to be included in the initial set of test cases. In some implementations, the initial set of test cases can be determined based on the output of the machine-learning model (described in greater detail below). For example, identifiers of functions that have been modified or the modified source code itself can be inputted into the machine-learning model, and the resulting output may include a list of test cases predicted to be the most appropriate to run on the modified application code. The outputted list of test cases may represent the initial set of test cases presented to the QA device 410.

Test prediction system 420 may include a network of one or more servers backed or supported by one or more databases. The one or more servers can be configured to perform any of the methods or processes described herein. In some implementations, test prediction system 420 may receive a digital signal representing a change made by QA device 410 to an initial set of test cases. For example, anytime a QA device in the testing framework or logged into a testing platform (including QA device 410, which may be one among many devices) selects to accept an initial set of test cases to execute on a unit of work delivery, the selection and the unit of work delivery (or an identifier representing the unit of work delivery) is transmitted to test prediction system 420 and stored therein in a data set. As another example, anytime a QA device that is logged into the testing platform adds one or more test cases to the initial set of test cases, the selection to add the one or more tests and the unit of work delivery (or an identifier representing the unit of work delivery) is transmitted to test prediction system 420 and stored therein in the data set. It will be appreciated that adding a test to the initial set of test cases can include creating an entirely new test. As yet another example, anytime a QA device logged into the testing platform removes one or more tests cases from the initial set of test cases, the selection to remove the one or more tests and the unit of work delivery (or an identifier representing the unit of work delivery) is transmitted to test prediction system 420 and stored therein in the data set. The data set may be large enough to be at big-data scale given the large number of QA devices testing portions of the source code. In some implementations, test prediction system 420 may train a machine-learning model using the collected data set. For example, the collected data set may include patterns that may be extracted or identified by one or more machine-learning algorithms. Continuing with the example, the one or more machine-learning algorithms may automatically identify a pattern indicating that units of work delivery including function X typically are tested using Test A, Test B, and Test C. Thus, the model is trained to generate an output of Test A, Test B, and Test C any time a unit of work delivery including function X is inputted into the model or evaluated by the model.

In some implementations, test prediction system 420 can include one or more models that are generated using machine-learning and/or artificial intelligence techniques. In some implementations, the model can be a contextual multi-armed bandit model with or without reinforcement learning techniques to optimize the tests included in the initial set of tests presented on QA device 410 for the test engineer to review. The reinforcement learning can enable the contextual model to dynamically determine which tests to include in the initial set of tests for exploration purposes (e.g., randomly chosen) and which tests to include in the initial set of tests that are predicted based on the test engineers previous testing history and/or the testing histories of other test engineers in the company. The contextual model can be updated based on feedback signals received from test engineers when test engineers accept, add, or remove tests from the initial set of tests. In some implementations, machine-learning algorithms or techniques used for the contextual model can include artificial neural networks (including backpropagation, Boltzmann machines, etc.), Bayesian statistics (e.g., Bayesian networks or knowledge bases), logistical model trees, support vector machines, information fuzzy networks, Hidden Markov models, hierarchical clustering (unsupervised), self-organizing maps, clustering techniques, and other suitable machine-learning techniques (supervised or unsupervised). For example, test prediction system 420 can retrieve one or more machine-learning algorithms stored in a data store (not shown) to generate an artificial neural network in order to identify patterns or correlations within the collected data set of selections and units of work delivery. As a further example, the artificial neural network can learn that when a unit of work delivery (in the data set) includes function A and function B, then Test C is predicted as relevant data for the test engineer. In yet another example, a support vector machine can be used either to generate output data that is used as a prediction, or to identify learned patterns within the collected data set.

To illustrate and only as a non-limiting example, code management system 430 may store a unit of work delivery that modifies function X. The unit of work delivery may be created by a developer updating the source code of an enterprise application that is configured to perform function X. The modifications made to the source code of function X need to be tested before the modifications can be fully integrated into the source code of the enterprise application. A test engineer operating QA device 410 may be presented with an initial set of test cases including Test A, Test B, and Test C to run on the modified source code of the enterprise application. The initial set of test cases may be identified based on user-defined rules, for example, by examining that a function has been updated in the unit of work delivery, and then, identifying the test cases that are relevant to check for errors caused by updated functions. Alternatively, the initial set of test cases may be identify by test prediction system 450 by inputting the unit of work delivery into the machine-learning model, and generating an output that corresponds to a list of test cases that are predicted to be relevant for checking for errors in the modified source code. The test engineer may determine that Test A, Test B, and Test C do not cover all of the potential bugs or errors that may arise by modifying function X. The test engineer may operate QA device 410 to select additional tests Test D and Test E to include in the set of test cases. The selection performed by QA device 410 that added Test D and Test E may be transmitted to test prediction system 420 for updating the machine-learning model stored therein. The machine-learning model may be modified so as to include Test D and Test E in any subsequently generated initial set of test cases for a similar or the same unit of work delivery (e.g., any updates involving modified function X made in the future). Test executing system 450 can also automatically execute each of Test A, Test B, Test C, Test D, and Test E so as to identify whether the modified source code caused any errors or bugs in the overall enterprise application. For example, test executing system 450 may include a network of one or more servers backed by at least one database. Test executing system 450 can automatically run any automated scripts included in the final set of tests. Test executing system 450 can also enable the test engineer to perform the tests if the tests are to be manually executed or performed. If no errors or bugs were identified by the running the tests cases, then the unit of work delivery may be integrated into the source code of the enterprise application. However, if executing the tests results in the identification of one or more errors or bugs, then the test engineer can address those bugs. In this case, the unit of work delivery would not be integrated into the source code of the enterprise application until the errors or bugs have been addressed.

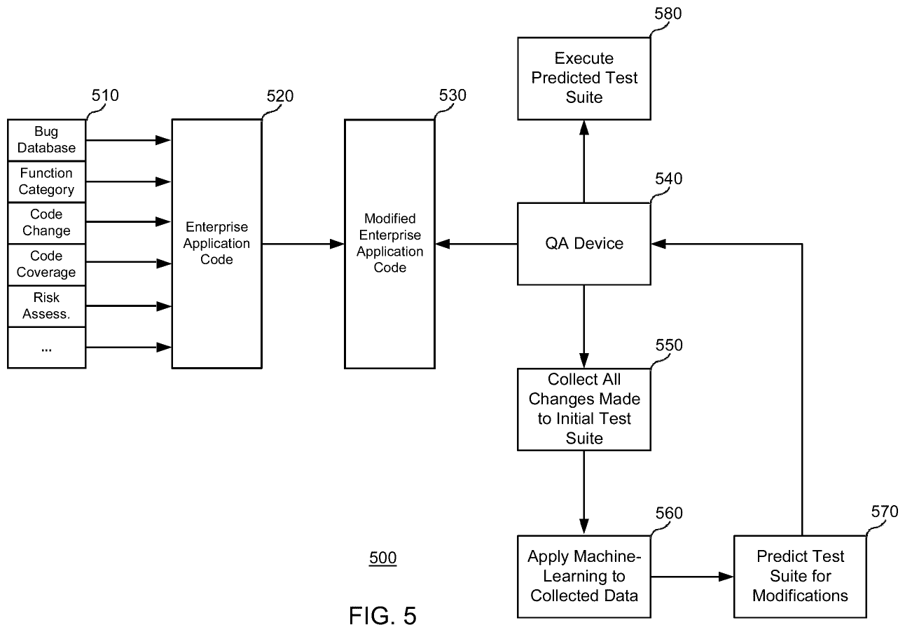

FIG. 5 is a diagram illustrating a process flow for intelligently selecting test cases using machine-learning and/or artificial intelligence techniques. Process flow 500 may be performed by any computing device or system described in FIG. 4 above. For example, process flow 500 may be performed at least in part by the test prediction system.

Process flow 500 may begin at block 510 where a developer creates a unit of work delivery relating to the source code of an enterprise application. The unit of work delivery may include or may perform any one or more of the following non-limiting examples: a bug or error, function category, code change, code coverage, risk assessment, and other suitable examples. At blocks 520 and 530, in many cases, the unit of work delivery may modify the source code of the enterprise application, but the present disclosure is not limited thereto. It will be appreciated that a unit of work delivery may not necessarily change the source code of the enterprise application. At block 540, the QA device, which may be operated by a test engineer, may be tasked with identifying a set of test cases to run on the unit of work delivery. According to certain embodiments, a test prediction system can intelligently predict which test cases are the best to select based on the unit of work delivery being analyzed. At block 550, the test prediction system collects all of the changes made to the initial set of tests by the test engineers. For example, if a test engineer adds a test to the initial set of tests, the test prediction system can update a machine-learning model to learn that the newly added test should be associated with the unit of work delivery for which the new test was added. That way, the test prediction system can add the newly-added test to the initial set of tests for any future units of work delivery that are the same or similar. At block 560, the test prediction system can train a model using the data set collected at step 560. For example, the test prediction system can execute one or more machine-learning algorithms on the collected data set to identify patterns within the data elements of the data set. The identified patterns may associate certain units of work delivery or certain types of units of work delivery to test cases. At block 570, the test prediction system may receive as an input a new unit of work delivery coded by a developer. The new unit of work delivery may include at least one change to the source code of the enterprise application. The test prediction system can evaluate the new unit of work delivery using the machine-learning model, which results in an output. The output of the machine-learning model may represent a set of tests that are predicted to be the most appropriate test cases to select to check for errors in the new unit of delivery or in a version of the source code that includes the new unit of work delivery. The predicted tests can be transmitted to the QA device for the test engineer to review. If the test engineer accepts the predicted set of tests, then the test prediction system receives a feedback signal indicating that the predicted set of tests was the correct set of tests to run on the new unit of work delivery. In this case, the model receives positive feedback indicating that the correlation or pattern between the new unit of work delivery and the predicted tests is currently accurate. The positive feedback is a signal for the model to predict the same tests in response to any future unit of work delivery that is the same or similar to the new unit of work delivery. If the test engineer rejects the predicted set of tests by adding a new test or removing a test from the predicted set of tests, then the test prediction system receives a feedback signal indicating that the predicted set of tests was not the correct set of tests to run on the new unit of work delivery. In this case, the model receives negative feedback indicating that the correlation or pattern between the new unit of work delivery and the predicted tests is not currently accurate. The negative feedback is a signal for the model to not predict the same tests in response to any future of unit of work delivery that is the same or similar to the new unit of work delivery. Instead, the negative feedback is a signal that updates the model to use the final set of tests selected by the test engineer in response to any future unit of work delivery that is the same or similar to the new unit of work delivery. Lastly, at block 580, the test executing system can automatically execute the final set of tests selected by the test engineer. If the tests are configured to be manually performed, then the test executing system can facilitate the execution of the tests.

It will be appreciated that process flow 500 may not be limited to the flow illustrated in FIG. 5, but rather process flow may selectively include any of the blocks described above in any order. Blocks may also be added or removed from process flow 500 to perform variations of the method or process described above.

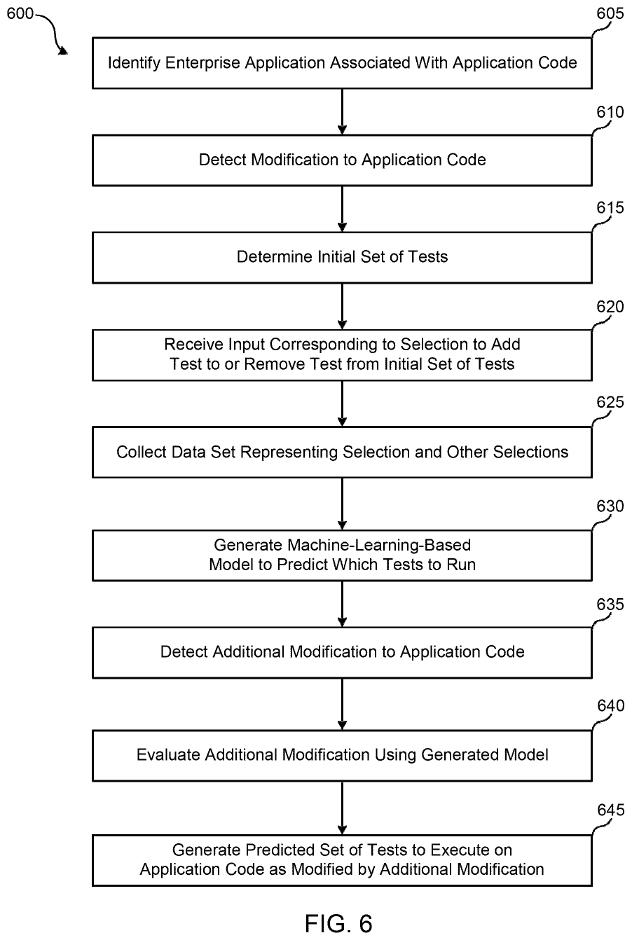

FIG. 6 is a flowchart illustrating an example process for intelligently selecting test cases using machine learning and/or artificial intelligence techniques. Process 600 may be performed to intelligently predict the most appropriate or best suited set of test cases to run on a unit of work delivery before integrating the unit of work delivery into the source code of an enterprise application. Further, process 600 may be performed at least in part by the test prediction system (e.g., test prediction system 420) and/or the QA device (e.g., QA device 410).

Process 600 begins at block 605, where an enterprise application is identified. In some implementations, the enterprise application may be a cloud-based platform that performs one or more services or functions to serve a company or organization. For example, PEOPLESOFT is an enterprise application that provides services for companies and organizations. The services or functions of the enterprise application may be performed by running source code (e.g., application code). At block 610, the test prediction system may detect a modification made to the application code. For example, a developer may create a unit of work delivery, which is a segment of code that modifies the original source code of the enterprise application. The unit of work delivery may modify the source code by adding new features, updating existing features, or removing existing features.

At block 615, the test prediction system may determine a set of tests (e.g., an initial set of test). In some implementations, the set of tests may be determined by evaluating the unit of work delivery. For example, the test prediction system may evaluate a unit of work delivery to identify that the unit of work delivery contains code modifications to function X within the source code. The test prediction system can determine the initial set of tests by passing the unit of work delivery through the machine-learning model to generate an initial set of tests to present to the test engineer. In some implementations, the test prediction system may determine the initial set of tests based on user-defined rules. For example, for the first instance that a test engineer uses the testing platform, the machine-learning model may not yet be trained, and thus, the initial set of tests may be determined by applying one or more user-defined rules to the unit of work delivery. For instance, if the unit of work delivery includes a code change to a function, a rule may exist to select a certain group of tests that are best suited to test errors or bugs that may arise from code changes to functions.

At block 620, the QA device may receive input from the test engineer. For example, the input may correspond to a selection of an additional test to include in the initial set of tests or of a test to remove from the initial set of tests. For example, the initial set of requests may include Test A, Test B, and Test C as being the most appropriate tests to run on the unit of work delivery (e.g., the group of tests that are sufficient to likely catch any bugs or errors created by the unit of work delivery). In this example, if the QA device receives input from the test engineer corresponding to a selection to add Test D and Test E to the initial set of tests, then the QA device can transmit a data signal to the test prediction system. The data signal may include data representing that Test D and Test E were added to the initial set of tests for the unit of work delivery being analyzed.

At block 625, the test prediction system can collect the data represented in the various data signals received from the QA device as a data set. For example, for all test engineers analyzing units of work delivery, every selection to accept, add, or remove (or any change to) a test from the initial set of tests can be logged and collected by the test prediction system as a data set. At block 630, the test prediction system can train one or more machine-learning models using the collected data set. For example, the test prediction system can generate a model that is configured to predict which tests to include in the set of tests based on an input of one or more units of work delivery. The model may be generated by training one or more machine-learning algorithms using the collected data set. The machine-learning model may be generated using any of the machine-learning or artificial intelligence techniques described above.

Blocks 605 through 630 above describe the steps taken to create the model that is later used to predict a set of tests to run on a unit of work delivery. Thus, once the model is initially created, process 600 moves to block 635, to detect another unit of work delivery that needs to be analyzed before being integrated into the source code of the enterprise application. It will be appreciated that, once the model is trained, the model is continuously updated with each new selection made by a QA device. At block 640, the new unit of work delivery is evaluated using the trained model. For example, the new unit of work delivery can be passed through the model as an input. As block 645, the output generated in response to passing the unit of work delivery through the model as an input can be one or more test identifiers. Each test identifier may uniquely identify a test. Further, the one or more tests represented by the one or more test identifiers may be a set of tests that the test prediction system recommends or predicts as being sufficient to catch any errors or bugs that the new unit of work delivery may cause in the source code.

It will be appreciated that the test prediction system can generate a list of tests that are predicted to be suitable for testing the unit of work delivery, and that the list of tests can be determined so as to be specific to the test engineer. For example, the data signal received at the test prediction system can include a unique identifier of the test engineer (in addition to the selection made by the test engineer and any associated metadata). The model can identify patterns of selections made by the specific test engineer, so that whenever the test engineer logs into the testing platform, the predictions presented to the test engineer may be based on the selections made by that test engineer or similar test engineers. It will also be appreciated that the test prediction system can identify patterns within selections made by other test engineers that share an attribute with the test engineer who is logged into the testing platform. For example, the test prediction system can predict the most suitable tests based on selections made by test engineers within the same state as the test engineer who is analyzing the unit of work delivery. Other non-limiting examples of shared attributes may include time of year, the enterprise application being analyzed, the department of the test engineer, and so on.

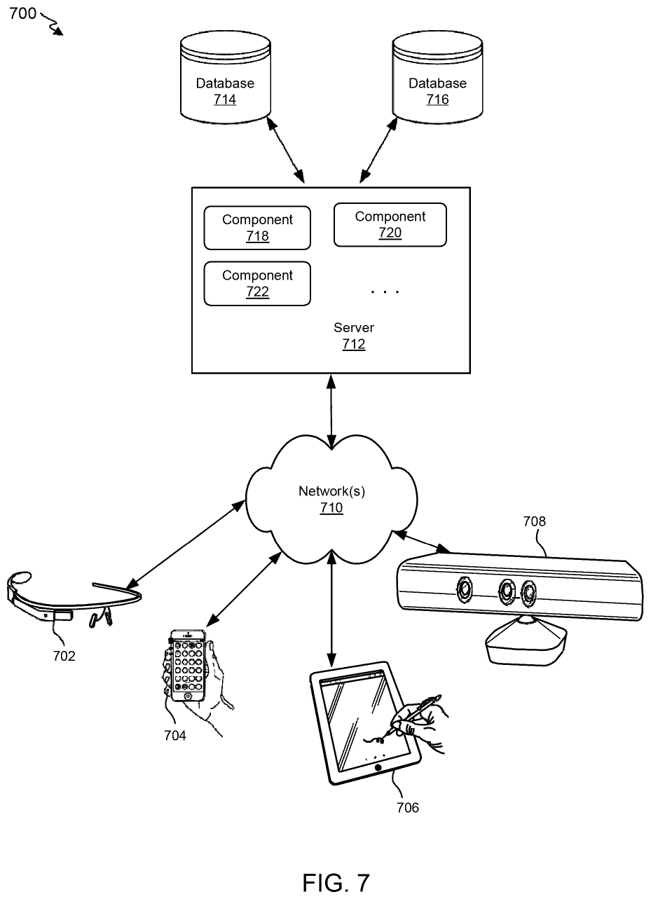

FIG. 7 depicts a simplified diagram of a distributed system 700 for implementing one of the embodiments. In the illustrated embodiment, distributed system 700 includes one or more client computing devices 702, 704, 706, and 708, which are configured to execute and operate a client application such as a web browser, proprietary client (e.g., Oracle Forms), or the like over one or more network(s) 710. Server 712 may be communicatively coupled with remote client computing devices 702, 704, 706, and 708 via network 710.

In various embodiments, server 712 may be adapted to ruin one or more services or software applications provided by one or more of the components of the system. In some embodiments, these services may be offered as web-based or cloud services or under a Software as a Service (Saas) model to the users of client computing devices 702, 704, 706, and/or 708. Users operating client computing devices 702, 704, 706, and/or 708 may in turn utilize one or more client applications to interact with server 712 to utilize the services provided by these components.

In the configuration depicted in the figure, the software components 718, 720 and 722 of system 700 are shown as being implemented on server 712. In other embodiments, one or more of the components of system 700 and/or the services provided by these components may also be implemented by one or more of the client computing devices 702, 704, 706, and/or 708. Users operating the client computing devices may then utilize one or more client applications to use the services provided by these components. These components may be implemented in hardware, firmware, software, or combinations thereof. It should be appreciated that various different system configurations are possible, which may be different from distributed system 700. The embodiment shown in the figure is thus one example of a distributed system for implementing an embodiment system and is not intended to be limiting.

Client computing devices 702, 704, 706, and/or 708 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 702, 704, 706, and 708 may be any other electronic device, such as a thin-client computer, an Internet-enabled gaming system (e.g., a Microsoft Xbox gaming console with or without a Kinect® gesture input device), and/or a personal messaging device, capable of communicating over network(s) 710.

Although exemplary distributed system 700 is shown with four client computing devices, any number of client computing devices may be supported. Other devices, such as devices with sensors, etc., may internet with server 712.

Network(s) 710 in distributed system 700 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 710 can be a local area network (LAN), such as one based on Ethernet, Token-Ring and/or the like. Network(s) 710 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 712 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 712 may be adapted to run one or more services or software applications described in the foregoing disclosure. For example, server 712 may correspond to a server for performing processing described above according to an embodiment of the present disclosure.

Server 712 may run an operating system including any of those discussed above, as well as any commercially available server operating system. Server 712 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 712 may include one or more applications to analyze and consolidate data feeds and/or event updates received from users of client computing devices 702, 704, 706, and 708. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 712 may also include one or more applications to display the data feeds and/or real-time events via one or more display devices of client computing devices 702, 704, 706, and 708.

Distributed system 700 may also include one or more databases 714 and 716. Databases 714 and 716 may reside in a variety of locations. By way of example, one or more of databases 714 and 716 may reside on a non-transitory storage medium local to (and/or resident in) server 712. Alternatively, databases 714 and 716 may be remote from server 712 and in communication with server 712 via a network-based or dedicated connection. In one set of embodiments, databases 714 and 716 may reside in a storage-area network (SAN). Similarly, any necessary files for performing the functions attributed to server 712 may be stored locally on server 712 and/or remotely, as appropriate. In one set of embodiments, databases 714 and 716 may include relational databases, such as databases provided by Oracle, that are adapted to store, update, and retrieve data in response to SQL-formatted commands.

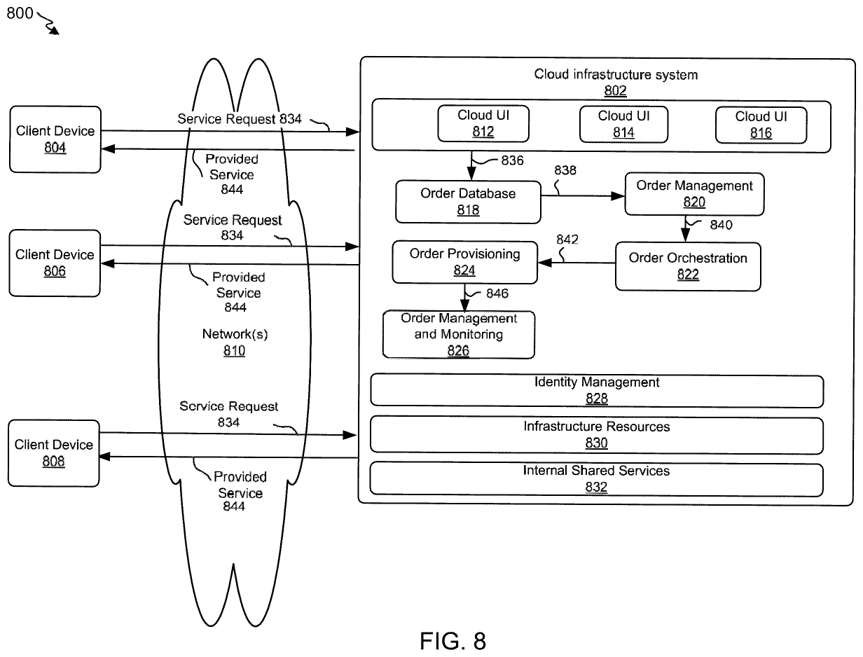

FIG. 8 is a simplified block diagram of one or more components of a system environment 800 by which services provided by one or more components of an embodiment system may be offered as cloud services, in accordance with an embodiment of the present disclosure. In the illustrated embodiment, system environment 800 includes one or more client computing devices 804, 806, and 808 that may be used by users to interact with a cloud infrastructure system 802 that provides cloud services. The client computing devices may be configured to operate a client application such as a web browser, a proprietary client application (e.g., Oracle Forms), or some other application, which may be used by a user of the client computing device to interact with cloud infrastructure system 802 to use services provided by cloud infrastructure system 802.

It should be appreciated that cloud infrastructure system 802 depicted in the figure may have other components than those depicted. Further, the embodiment shown in the figure is only one example of a cloud infrastructure system that may incorporate an embodiment of the invention. In some other embodiments, cloud infrastructure system 802 may have more or fewer components than shown in the figure, may combine two or more components, or may have a different configuration or arrangement of components.

Client computing devices 804, 806, and 808 may be devices similar to those described above for 702, 704, 706, and 708.

Although exemplary system environment 800 is shown with three client computing devices, any number of client computing devices may be supported. Other devices such as devices with sensors, etc. may interact with cloud infrastructure system 802.

Network(s) 810 may facilitate communications and exchange of data between clients 804, 806, and 808 and cloud infrastructure system 802. Each network may be any type of network familiar to those skilled in the art that can support data communications using any of a variety of commercially-available protocols, including those described above for network(s) 710.

Cloud infrastructure system 802 may comprise one or more computers and/or servers that may include those described above for server 712.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 802 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 802 may be adapted to automatically provision, manage and track a customer's subscription to services offered by cloud infrastructure system 802. Cloud infrastructure system 802 may provide the cloud services via different deployment models. For example, services may be provided under a public cloud model in which cloud infrastructure system 802 is owned by an organization selling cloud services (e.g., owned by Oracle) and the services are made available to the general public or different industry enterprises. As another example, services may be provided under a private cloud model in which cloud infrastructure system 802 is operated solely for a single organization and may provide services for one or more entities within the organization. The cloud services may also be provided under a community cloud model in which cloud infrastructure system 802 and the services provided by cloud infrastructure system 802 are shared by several organizations in a related community. The cloud services may also be provided under a hybrid cloud model, which is a combination of two or more different models.

In some embodiments, the services provided by cloud infrastructure system 802 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 802. Cloud infrastructure system 802 then performs processing to provide the services in the customer's subscription order.

In some embodiments, the services provided by cloud infrastructure system 802 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 802 may also include infrastructure resources 830 for providing the resources used to provide various services to customers of the cloud infrastructure system. In one embodiment, infrastructure resources 830 may include pre-integrated and optimized combinations of hardware, such as servers, storage, and networking resources to execute the services provided by the PaaS platform and the SaaS platform.

In some embodiments, resources in cloud infrastructure system 802 may be shared by multiple users and dynamically re-allocated per demand. Additionally, resources may be allocated to users in different time zones. For example, cloud infrastructure system 830 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 832 may be provided that are shared by different components or modules of cloud infrastructure system 802 and by the services provided by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 802 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 802, and the like.

In one embodiment, as depicted in the figure, cloud management functionality may be provided by one or more modules, such as an order management module 820, an order orchestration module 822, an order provisioning module 824, an order management and monitoring module 826, and an identity management module 828. These modules may include or be provided using one or more computers and/or servers, which may be general purpose computers, specialized server computers, server farms, server clusters, or any other appropriate arrangement and/or combination.

In exemplary operation 834, a customer using a client device, such as client device 804, 806 or 808, may interact with cloud infrastructure system 802 by requesting one or more services provided by cloud infrastructure system 802 and placing an order for a subscription for one or more services offered by cloud infrastructure system 802. In certain embodiments, the customer may access a cloud User Interface (UI), cloud UI 812, cloud UI 814 and/or cloud UI 816 and place a subscription order via these UIs. The order information received by cloud infrastructure system 802 in response to the customer placing an order may include information identifying the customer and one or more services offered by the cloud infrastructure system 802 that the customer intends to subscribe to.

After an order has been placed by the customer, the order information is received via the cloud UIs, 812, 814 and/or 816.

At operation 836, the order is stored in order database 818. Order database 818 can be one of several databases operated by cloud infrastructure system 818 and operated in conjunction with other system elements.

At operation 838, the order information is forwarded to an order management module 820. In some instances, order management module 820 may be configured to perform billing and accounting functions related to the order, such as verifying the order, and upon verification, booking the order.

At operation 840, information regarding the order is communicated to an order orchestration module 822. Order orchestration module 822 may utilize the order information to orchestrate the provisioning of services and resources for the order placed by the customer. In some instances, order orchestration module 822 may orchestrate the provisioning of resources to support the subscribed services using the services of order provisioning module 824.

In certain embodiments, order orchestration module 822 enables the management of business processes associated with each order and applies business logic to determine whether an order should proceed to provisioning. At operation 842, upon receiving an order for a new subscription, order orchestration module 822 sends a request to order provisioning module 824 to allocate resources and configure those resources needed to fulfill the subscription order. Order provisioning module 824 enables the allocation of resources for the services ordered by the customer. Order provisioning module 824 provides a level of abstraction between the cloud services provided by cloud infrastructure system 800 and the physical implementation layer that is used to provision the resources for providing the requested services. Order orchestration module 822 may thus be isolated from implementation details, such as whether or not services and resources are actually provisioned on the fly or pre-provisioned and only allocated/assigned upon request.

At operation 844, once the services and resources are provisioned, a notification of the provided service may be sent to customers on client devices 804, 806 and/or 808 by order provisioning module 824 of cloud infrastructure system 802.

At operation 846, the customer's subscription order may be managed and tracked by an order management and monitoring module 826. In some instances, order management and monitoring module 826 may be configured to collect usage statistics for the services in the subscription order, such as the amount of storage used, the amount data transferred, the number of users, and the amount of system up time and system down time.

In certain embodiments, cloud infrastructure system 800 may include an identity management module 828. Identity management module 828 may be configured to provide identity services, such as access management and authorization services in cloud infrastructure system 800. In some embodiments, identity management module 828 may control information about customers who wish to utilize the services provided by cloud infrastructure system 802. Such information can include information that authenticates the identities of such customers and information that describes which actions those customers are authorized to perform relative to various system resources (e.g., files, directories, applications, communication ports, memory segments, etc.) Identity management module 828 may also include the management of descriptive information about each customer and about how and by whom that descriptive information can be accessed and modified.

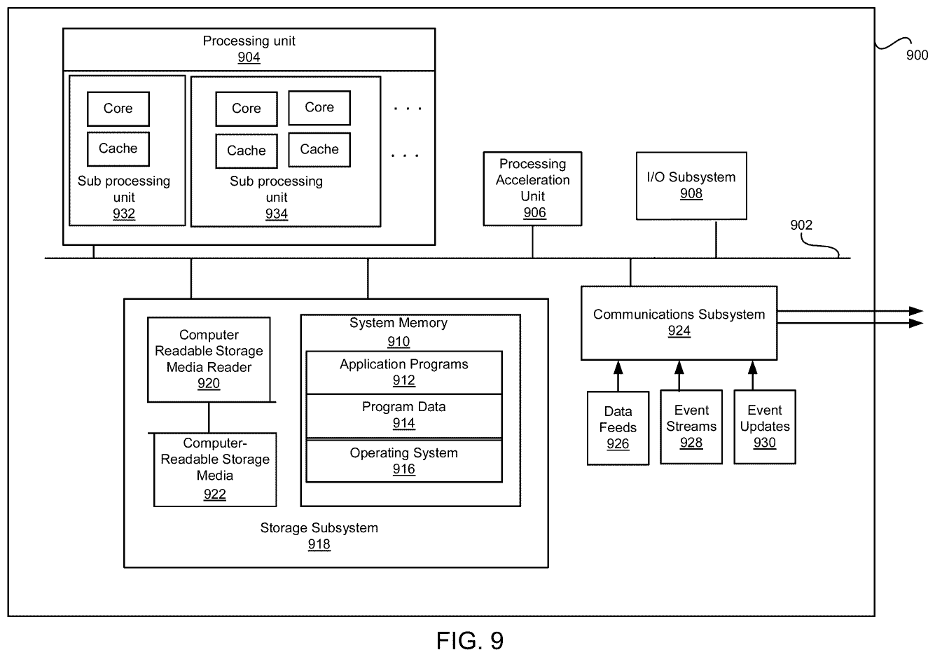

FIG. 9 illustrates an exemplary computer system 900, in which various embodiments of the present invention may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g. Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.). The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present invention.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
identifying an enterprise application configured to perform one or more functions, the enterprise application being executed using application code;
detecting a modification to the application code;
determining a set of tests, the determination being based at least in part on the modification to the application code, and each test of the set of tests being executable to detect an error in the modified application code;
receiving input corresponding to a selection of an additional test to include in the set of tests or of a test to remove from the set of tests;
collecting a data set representing the selection and one or more additional selections, each of the selection and the one or more additional selections representing a change to the set of tests;
generating a model to predict which tests to include in the set of tests, the model being generated by training one or more machine-learning algorithms using the collected data set;
detecting an additional modification to the application code;
evaluating the additional modification using the generated model; and
in response to evaluating the additional modification using the generated model, generating a predicted set of tests to execute on the application code as modified by the additional modification.

2. The computer-implemented method of claim 1, wherein the modification to the application code or the additional modification to the application code represents any one or more of the following group: a code change, code coverage, risk classification, history of outstanding bugs, a function category, and a previous selection log.

3. The computer-implemented method of claim 1, wherein the determined set of tests represents an initial set of tests determined using the model and determined based on the modification to the application code.

4. The computer-implemented method of claim 1, further comprising:
determining whether or not the predicted set of tests include automated script; and
in response to determining that the predicted set of tests includes automated script, automatically executing the automated script to test the application code as modified by the additional modification for errors.

5. The computer-implemented method of claim 1, wherein the enterprise application performs the one or more functions in association with an enterprise.

6. The computer-implemented method of claim 1, wherein the one or more additional selections represent one or more changes made to an additional set of tests, wherein the additional set of tests are determined based on another modification made to the application code.

7. The computer-implemented method of claim 1, wherein collecting the data set further includes:
storing a representation of the change made to the set of tests; and
in association with storing the representation of the change, storing an identifier representing the modification to the application code.

8. A system, comprising:
one or more data processors; and
a non-transitory computer-readable storage medium containing instructions which, when executed on the one or more data processors, cause the one or more data processors to perform operations including:
identifying an enterprise application configured to perform one or more functions, the enterprise application being executed using application code;
detecting a modification to the application code;
determining a set of tests, the determination being based at least in part on the modification to the application code, and each test of the set of tests being executable to detect an error in the modified application code;
receiving input corresponding to a selection of an additional test to include in the set of tests or of a test to remove from the set of tests;
collecting a data set representing the selection and one or more additional selections, each of the selection and the one or more additional selections representing a change to the set of tests;
generating a model to predict which tests to include in the set of tests, the model being generated by training one or more machine-learning algorithms using the collected data set;
detecting an additional modification to the application code;
evaluating the additional modification using the generated model; and
in response to evaluating the additional modification using the generated model, generating a predicted set of tests to execute on the application code as modified by the additional modification.

9. The system of claim 8, wherein the modification to the application code or the additional modification to the application code represents any one or more of the following group: a code change, code coverage, risk classification, history of outstanding bugs, a function category, and a previous selection log.

10. The system of claim 8, wherein the determined set of tests represents an initial set of tests determined using the model and determined based on the modification to the application code.

11. The system of claim 8, wherein the operations further comprise:
determining whether or not the predicted set of tests include automated script; and
in response to determining that the predicted set of tests includes automated script, automatically executing the automated script to test the application code as modified by the additional modification for errors.

12. The system of claim 8, wherein the enterprise application performs the one or more functions in association with an enterprise.

13. The system of claim 8, wherein the one or more additional selections represent one or more changes made to an additional set of tests, wherein the additional set of tests are determined based on another modification made to the application code.

14. The system of claim 8, wherein collecting the data set further includes:
storing a representation of the change made to the set of tests; and
in association with storing the representation of the change, storing an identifier representing the modification to the application code.

15. A computer-program product tangibly embodied in a non-transitory machine-readable storage medium, including instructions configured to cause a data processing apparatus to perform operations including:
identifying an enterprise application configured to perform one or more functions, the enterprise application being executed using application code;
detecting a modification to the application code;
determining a set of tests, the determination being based at least in part on the modification to the application code, and each test of the set of tests being executable to detect an error in the modified application code;
receiving input corresponding to a selection of an additional test to include in the set of tests or of a test to remove from the set of tests;
collecting a data set representing the selection and one or more additional selections, each of the selection and the one or more additional selections representing a change to the set of tests;
generating a model to predict which tests to include in the set of tests, the model being generated by training one or more machine-learning algorithms using the collected data set;
detecting an additional modification to the application code;
evaluating the additional modification using the generated model; and
in response to evaluating the additional modification using the generated model, generating a predicted set of tests to execute on the application code as modified by the additional modification.

16. The computer-program product of claim 15, wherein the modification to the application code or the additional modification to the application code represents any one or more of the following group: a code change, code coverage, risk classification, history of outstanding bugs, a function category, and a previous selection log.

17. The computer-program product of claim 15, wherein the determined set of tests represents an initial set of tests determined using the model and determined based on the modification to the application code.

18. The computer-program product of claim 15, wherein the operations further comprise:
determining whether or not the predicted set of tests include automated script; and
in response to determining that the predicted set of tests includes automated script, automatically executing the automated script to test the application code as modified by the additional modification for errors.

19. The computer-program product of claim 15, wherein the enterprise application performs the one or more functions in association with an enterprise.

20. The computer-program product of claim 15, wherein the one or more additional selections represent one or more changes made to an additional set of tests, wherein the additional set of tests are determined based on another modification made to the application code.
